(19) United States
(12) Patent Application Publication
(10) Pub. No.: US 2025/0187317 A1
(43) Pub. Date: Jun. 12, 2025

(54) ROOFING COVER BOARD WITH RECYCLED ROOFING MEMBRANE

(71) Applicant: Thomas L. Kelly, Waterbury, CT (US)

(72) Inventor: Thomas L. Kelly, Waterbury, CT (US)

(21) Appl. No.: 18/971,645

(22) Filed: Dec. 6, 2024

Related U.S. Application Data
(60) Provisional application No. 63/607,414, filed on Dec. 7, 2023.

(51) Int. Cl. B32B 27/10; B32B 3/04; B32B 3/26; B32B 25/06; B32B 25/16; B32B 27/18; B32B 27/28; B32B 27/30; B32B 27/32; B32B 27/36; E04D 11/02

(52) U.S. Cl. CPC B32B 27/10; B32B 3/04; B32B 3/266; B32B 25/06; B32B 25/16; B32B 27/18; B32B 27/288; B32B 27/304; B32B 27/32; B32B 27/36; E04D 11/02; B32B 2272/00; B32B 2274/00; B32B 2307/718; B32B 2307/7265; B32B 2419/06

(57) ABSTRACT

A cover board for use in a roofing system includes a core including material from at least one recycled roof membrane. The core has a first major surface and a second major surface. A facing layer is positioned adjacent to at least one of the first major surface and the second major surface.

### CROSS-REFERENCE TO RELATED APPLICATIONS

This application claims the benefit of U.S. Application No. 63/607,414, filed Dec. 7, 2023, the contents of which are incorporated by reference herein in their entirety.

### BACKGROUND

Exemplary embodiments of the invention relate to a roofing system, and more particularly, to a cover board for use in a roofing system.

Commercial and residential buildings having a roof deck typically include a roofing system having at least one layer of insulation, a layer of roofing cover boards that overlie the one or more layers of insulation, and a waterproofing membrane that overlies the upper surface of the cover boards. The insulation is susceptible to damage, such as from the weather and other causes commonly encountered in roofing construction. The rigidity of the roofing cover board is intended to protect the more fragile insulation from damage. The waterproofing membrane overlying the cover board layer protects both the cover board and the insulation from moisture and other adverse climatic conditions. Normally, these three components are installed in succession to build the roofing system for a flat or low-slope roof deck. These components may be coupled via mechanical fasteners, adhesive bonding, and/or ballasting, and may be aerodynamically vacuum packed to a monolithic air-sealed substrate or deck through equalizer valves strategically places in the wind uplift vortex intensity zones of a building's roof.

While these roofing systems function well, there remains a need to provide improved roofing cover boards.

### BRIEF SUMMARY

According to one embodiment, a cover board for use in a roofing system includes a core including material from at least one recycled roof membrane. The core has a first major surface and a second major surface. A facing layer is positioned adjacent to at least one of the first major surface and the second major surface.

In addition to one or more of the features described herein, or as an alternative, in further embodiments the material from the at least one recycled roof membrane includes a thermoplastic membrane.

In addition to one or more of the features described herein, or as an alternative, in further embodiments the material from the at least one recycled roof membrane includes a polyvinyl chloride (PVC).

In addition to one or more of the features described herein, or as an alternative, in further embodiments the material from the at least one recycled roof membrane includes a thermoplastic polyolefin (TPO).

In addition to one or more of the features described herein, or as an alternative, in further embodiments the material from the at least one recycled roof membrane includes a Ketone Ethylene Ester (KEE).

In addition to one or more of the features described herein, or as an alternative, in further embodiments the material from the at least one recycled roof membrane includes a thermoset membrane.

In addition to one or more of the features described herein, or as an alternative, in further embodiments the material from the at least one recycled roof membrane includes an ethylene propylene diene terpolymer (EPDM).

In addition to one or more of the features described herein, or as an alternative, in further embodiments the core includes a compatible plastic material and the material from the at least one recycled roof membrane is encapsulated by the compatible plastic material.

In addition to one or more of the features described herein, or as an alternative, in further embodiments the compatible plastic material includes polyester.

In addition to one or more of the features described herein, or as an alternative, in further embodiments the compatible plastic material includes polyethylene.

In addition to one or more of the features described herein, or as an alternative, in further embodiments the compatible plastic material includes polyvinyl chloride.

In addition to one or more of the features described herein, or as an alternative, in further embodiments the core has at least one region and a concentration of the material from the at least one recycled roof membrane within the at least one region is greater than a concentration of the material from the at least one recycled roof membrane within a remainder of the core.

In addition to one or more of the features described herein, or as an alternative, in further embodiments the at least one region includes an area for receiving fasteners when the cover board is installed in the roofing system.

In addition to one or more of the features described herein, or as an alternative, in further embodiments the material from the at least one recycled roof membrane is strengthened by at least one additive.

In addition to one or more of the features described herein, or as an alternative, in further embodiments the at least one additive includes chopped organic fibers.

In addition to one or more of the features described herein, or as an alternative, in further embodiments the at least one additive includes chopped inorganic fibers.

In addition to one or more of the features described herein, or as an alternative, in further embodiments the facing layer includes a sheet of recycled roof membrane.

In addition to one or more of the features described herein, or as an alternative, in further embodiments the facing layer includes a construction paper.

In addition to one or more of the features described herein, or as an alternative, in further embodiments the cover board has a weight between 1 pound/square foot and 25 pounds/square foot.

In addition to one or more of the features described herein, or as an alternative, in further embodiments the core of the cover board is waterproof.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a cover board for use in a roofing application according to an embodiment;

FIG. 2 is a cross-sectional view of a cover board having a core including recycle roof membrane material according to an embodiment;

FIG. 3 is a is a cross-sectional view of a cover board having a core including recycle roof membrane material and additives according to an embodiment;

FIG. 4 is a cross-sectional view of a cover board having a one or more facing layers according to an embodiment;

FIG. 5 is a perspective view of a cover board according to an embodiment; and

FIG. 6 is a cross-sectional view of a large cover board according to an embodiment.

The detailed description explains embodiments of the invention, together with advantages and features, by way of example with reference to the drawings.

### DETAILED DESCRIPTION

The embodiments described herein relate to a roofing system and a weighted cover board suitable for use therein.

The two most prevalent classes of waterproofing membranes typically used in roofing applications are thermoset membranes and thermoplastic membranes. Thermoset membranes are typically formed from rubber or synthetic rubber, such as ethylene propylene diene terpolymer (EPDM) rubber or Neoprene for example. Thermoplastic membranes are typically including thermoplastic materials, such as polyvinyl chloride (PVC), thermoplastic olefin (TPO), or Ketone Ethylene Ester (KEE) for example. It should be appreciated that these materials are provided as an example only and that thermoset and thermoplastic membranes formed from other materials are also contemplated herein. Such material can take thousands, and in some instances tens of thousands of years to degrade. In an attempt to reduce the amount of roofing materials provided to landfills, processes for recycling such membranes have been developed. For instance, the membrane can be shredded or ground into flakes and/or a powder-like substance. Such material has been used to make walkway pads as well as new roofing membranes. In embodiments where the membrane being recycled has a backing, such as a felt backing for example, the recycling process may additionally include removal of the backing. Alternatively, or in addition, in embodiments where the roofing membrane includes a scrim reinforcing material, the process may include extracting the scrim material from the polymer matrix of the membrane.

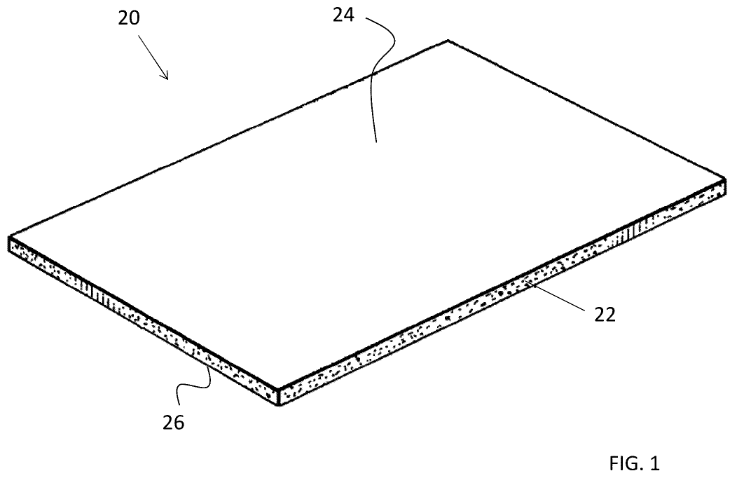

In an embodiment, all or a portion of a recycled roof membrane may be used in the formation of a weighted coverboard. With reference now to FIG. 1, a perspective view of an example of a cover board 20 configured for use in building applications is illustrated. The cover board 20 may be used in a variety of applications within a roofing system, such as for overlayment, underlayment, as a separator board, as a vapor barrier substrate, and as a recover board in reroofing applications. Although the cover board 20 is described with reference to a roofing system, it should be understood that the cover board 20 described herein may also be used in other building applications. For example, the cover board 20 may be configured to replace plywood applied to the exterior of a housing frame.

The weight of the cover board 20 is generally between about 1 pound per square foot and about 15 pounds per square foot, such as between 1-10 pounds per square foot, between 1-5 pounds per square foot, between 1-3 pounds per square foot, between 1 and 2.5 pounds per square foot, between 3 and 10 pounds per square foot, between 4 and 10 pounds per square foot, or between 5 and 10 pounds per square foot. The weight of the cover board 20 may vary in part based on the thickness of the cover board 20 and is selected based on the intended application of the cover board 20.

In the non-limiting embodiment illustrated in FIG. 1, the cover board 20 is generally rectangular in shape. However, it should be understood that a cover board 20 having any shape is within the scope of the disclosure. As shown, the cover board 20 includes a core 22 having a first major surface 24 and a second major surface 26 arranged at opposing sides thereof. The first major surface 24 and the second major surface 26 are defined as the surfaces of the cover board 20 having the greatest surface area. In the illustrated, non-limiting embodiment, the first and second major surfaces 24, 26 are defined by the length and width of the cover board 20. At least one of the first major surface 24 and the second major surface 26 is positionable in contact with a surface to which the cover board 20 is mounted, such as a wall or a roof deck for example.

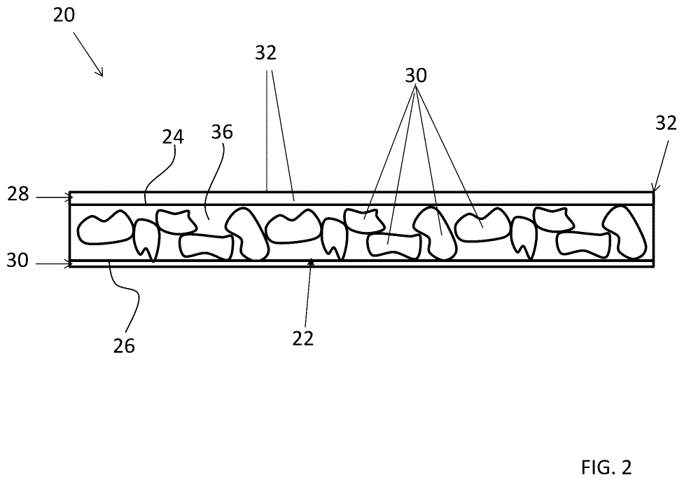

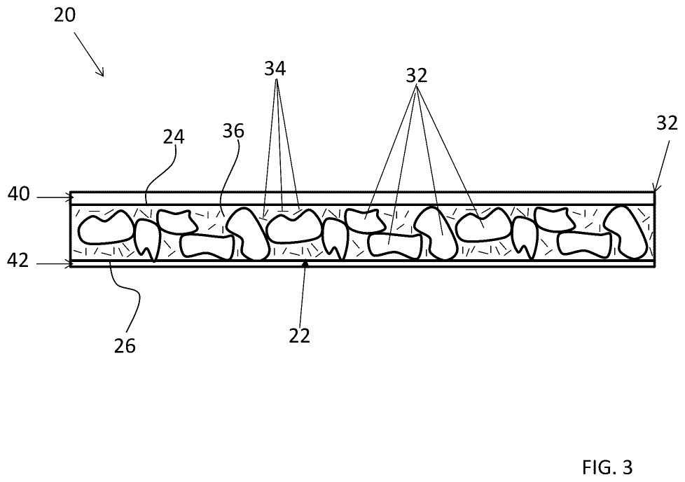

The composite material of the core 22 of the cover board 20 is formed entirely from recycled materials. For example, the core 22 of the cover board 20 may include material 30 from at least one recycled roof membrane. With reference to FIGS. 2 and 3, in some embodiments, the core 22 of the cover board 20 includes material 30 from a plurality of recycled roof membranes. As used herein, the term “recycled roof membrane” is intended to include any roofing membrane that was previously installed in a roofing application. In some embodiments, the recycled roof membrane may have undergone one or more processing operations after being removed from a roofing installation, such as described above. In embodiments including material 30 from a plurality of recycled roof membranes, it should be appreciated that the roof membranes may be formed from the same material, or alternatively, from different materials. Further, it should be appreciated that any portion of the recycled roof membrane, such as the membrane itself and/or the scrim material for example, may be incorporated into the core 22. Furthermore, these materials 30 may be in any suitable format, such as grinds, powder, pellets, flakes, or ribbons for example, when integrated into the core 22. The size of the individual pieces 30 of recycled roof membrane material used may vary based on the desired strength of the resulting cover board 20. For example, in an application requiring a higher strength cover board 20, larger grinds or flakes 30 of recycled roof material may be used than in a lower strength cover board.

In an embodiment, best shown in FIG. 3, one or more additives 32 may be mixed with the recycled roof membrane material 30 to form the core 22 of the cover board 20. Examples of such additives 32 include but are not limited to chopped organic fibers, such as hemp, straw, and bamboo, chopped inorganic fibers, such as fiberglass, nylon, polyester, and synthetic fibers such as Teflon.

In addition to the recycled roof membrane material 30, in some embodiments, a recycled compatible plastic material 36 is also incorporated into the core 22 of the cover board. The recycled compatible plastic material 36 may be any suitable plastic material, including but not limited to polyester, polyethylene, and polyvinyl chloride. The recycled compatible plastic material may be integral with the one or more recycled roof membrane materials 30 when added to the core 22, or alternatively, may be separate therefrom. In an embodiment where the compatible plastic material 36 is separate from the one or more recycled roof membrane materials 30, the compatible plastic material 36 may but need not be a byproduct of the recycling process of the roof membrane. As will be described in more detail below, as the material 30 of the recycled roof membrane compatible plastic material 36 are heated and compressed, the compatible plastic material 36 will melt and bind the recycled roof membrane material 30 into a solid core 22.

In the illustrated, non-limiting embodiment of FIGS. 2 and 3, the core 22 is formed solely from recycled roof membrane material and compatible plastic material. However, in other embodiments, the core 22 of the cover board 20 may additionally include one or more pieces of plastic-coated paperboard, such as beverage cartons and cups, and freezer food cartons (i.e., ice cream cartons) for example. Although the term “plastic-coated paperboard” is being used, it should be understood that the term paperboard is intended to include any suitable paper product, including but not limited to cardboard and heavy paper for example. In some embodiments including a combination of recycled roof membrane and plastic-coated paperboard, 5-45% of the core 22 is formed from plastic-coated paperboard and 55-95% of the core 22 is formed from recycled roof membrane and compatible plastic material. During formation, the plastic of the plastic-coated paperboard melts and acts as a binder for the non-meltable materials within the core.

To form the core 22 of the cover board 20, material 30 from one or more recycled roof membranes is provided to a fixture, such as a press for example. In some embodiments, one or more compatible plastic materials 36 are intermixed with the recycled roof membrane material 30 within the fixture. Alternatively, or in addition, shredded pieces of plastic-coated paperboard may be mixed with the recycled roof membrane material 30, and in some instances with the compatible plastic materials 36. The mixture of materials within the fixture is heated and compressed to form a core 22 having a desired thickness. The heating and compression may occur simultaneously. As the mixture is heated, the compatible plastic material 36 melts and acts as a binder for the recycled roof materials 30 and any other non-meltable material within the core 22. In an embodiment, the melted plastic 36 encapsulates or substantially encapsulates the recycled roof material 30 and/or any other non-meltable material within the core 22. Accordingly, the core 22 may be formed without the use of water, adhesive, formaldehyde glues, or other hazardous chemicals. As a result, the cover board 20 is free from volatile organic compounds.

A cover board 20 having a core 22 including recycled roof membrane material 30 provides several benefits over existing cover boards. First, the shredded roof membrane material is denser than previously used plastic-coated paperboard. Accordingly, a heavier weight per square foot can be achieved without changing the thickness of the cover board 20 by controlling the amount of recycled roof membrane material 30 within the core 22. Further, a cover board 20 including recycled roof membrane material 30 has increased structural stability and will increase a building's structural resistance to shear and racking forces when installed in a roofing system. In addition, the recycled roof membrane material 30 has an increased water resistance compared to the plastic-coated paperboard. As a result, a cover board 20 having a core 22 formed with recycled roof membrane material 30 is not prone to warping as a result of moisture and will not deteriorate when exposed to water. Furthermore, in embodiments where the core 22 does not include any plastic-coated paperboard, the cover board 20 is free from organic material that can decompose.

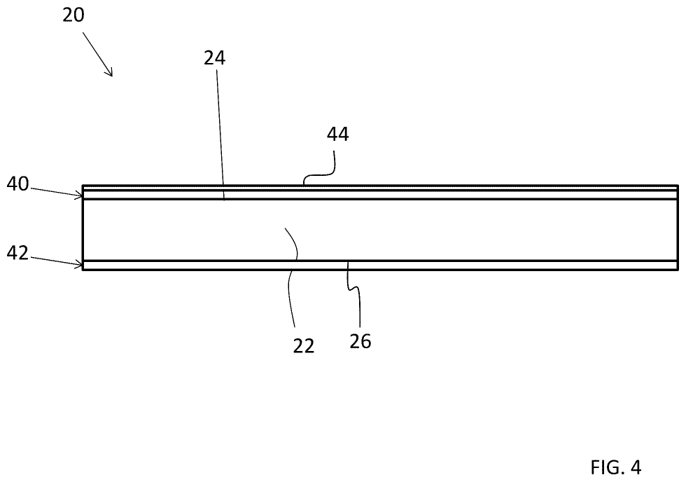

With continued reference to FIGS. 2 and 3, and further reference to FIG. 4, the cover board 20 may include a first facing layer 40 and/or a second facing layer 42 in an overlapping arrangement with the first and second major surfaces 24, 26, respectively. The facing layers 40, 42 may be configured to overlap the entirety, or only a portion, of a corresponding major surface 24, 26. Further, it should also be understood that embodiments where the first facing layer 40 and/or the second facing layer 42 extend over additional surfaces of the cover board 20 besides the major surfaces 24, 26 are also within the scope of the disclosure. The first and second facing layers 40, 42 may be any sheet material suitable for use with the cover board 20, such as paper or a woven material for example. In embodiments where the cover board 20 includes both a first facing layer 40 and a second facing layer 42, the first and second facing layers 40, 42 may, but need not be, formed from the same material or overlie the same portion of the cover board 20.

Conventional facing layers 40, 42 may be formed from a Kraft paper material. The Kraft paper may be any color, such as brown or white for example. However, in other embodiment, at least one of the first facing layer 40 and the second facing layer 42 may comprise another type of material. For example, in an embodiment, at least one of the facing layers 40, 42, may include a fiberglass coating containing one or more layers of a fiberglass material. The one or more layers of fiberglass material may overlie at least one of the major surfaces 24, 26 of the cover board 20. In such embodiments, the thickness of the facing layer 40, 42 including a fiberglass coating may be the same, or alternatively, may be different, for example greater, than if the facing layer 40, 42 is formed from another material, such as Kraft paper for example.

Fiberglass material is less susceptible to failure in shear than other materials used in roofing systems and as a result, the overall strength of the cover board 20 having at least one facing layer 40, 42 including a fiberglass coating is enhanced. In addition, inclusion of a fiberglass coating will augment the fire-resistant properties of the cover board 20. Because fiberglass does not burn under normal circumstances, a fiberglass coating will assist in maintaining the structural integrity of the cover board 20 in the event of a fire. Accordingly, the fire-resistant properties of the recycled core 22 may be improved by application of a fiberglass coating such that the cover board 20 is sufficient to act as a fire barrier as required by commercial and residential building codes. In addition, a fire coating material, such as silicone for example, adheres more effectively to the cover board 20 having the fiberglass coating than a cover board 20 without such a coating.

In embodiments where the cover board 20 includes a fiberglass coating directly or indirectly overlying at least one of the first major surface 24 and the second major surface 26, the core 22 may include additional plastic material, illustrated schematically at 36, compared to a core 22 of the cover board 20 without a fiberglass coating. The inclusion of this additional plastic material 36 will strengthen the bond formed between the fiberglass coating and the core 22 of the cover board 20. In an embodiment, the additional plastic material may be added through the entire core 22.

In another embodiment, at least one of the first facing layer 40 and the second facing layer 42 may comprise a foil coating, such as formed from one or more layers of a foil material for example. The at least one layer of foil material may be located directly adjacent the core 22. The thickness of a facing layer 40, 42 including a foil coating may be the same, or alternatively, may be different, for example greater, than if the facing layer 40, 42 is formed from another material, such as Kraft paper, or fiberglass for example. The coating materials illustrated and described herein are intended as an example only. Alternatively, or in addition, at least one of the first facing layer 40 and the second facing layer 42 may include a cellophane material. The cellophane may but need not be located directly adjacent the core 22. The cellophane may be used independently of in combination with any of the other suitable facing materials, such as fiberglass, Kraft paper, foil, and silicone for example. In another embodiment, a facing layer 40, 42 of the cover board 20 is formed from recycled roof membrane material 30. In such embodiments, the recycled roof membrane material 30 may be in the form of a sheet or may have any other suitable form.

The facing layers 40, 42 described herein, i.e., Kraft paper, fiberglass coating, and foil coating, are affixed to a corresponding major surface 24, 26 of the core 22 via any suitable means. In an embodiment, regardless of material, the facing layers 40, 42 are affixed to a surface of the core 22 without the use of a glue or mechanical fastener for example. In an embodiment, the facing layers 40, 42 are positioned between a heated surface of a press and the uncompressed recycled material of the core 22 during manufacturing. The facing layers 40, 42 function as carrier films that prevent the surface of the press from undesirably sticking to the core 22 after compression has occurred. As a result, during manufacturing, the melted plastic within the core 22 acts as an adhesive to integrally form the facing layers 40, 42 with the exterior surfaces of the core 22.

With reference to FIG. 4, a secondary coating 44 may be applied to one or more of the facing layers 40, 42 of the cover board 20. In an embodiment, the secondary coating 44 is a sealant, such as a fire proof material or silicone roof coating for example; however, other suitable sealants are also contemplated herein. A sealant 44 is particularly useful when applied to a facing layer comprising a fiberglass coating, or a facing layer comprising a Kraft paper. Alternatively, the secondary coating 44 may be applied to the facing layers 40, 42 to make the cover board 20 easier to handle. One example of a secondary coating 44 intended for such a purpose includes a clay material.

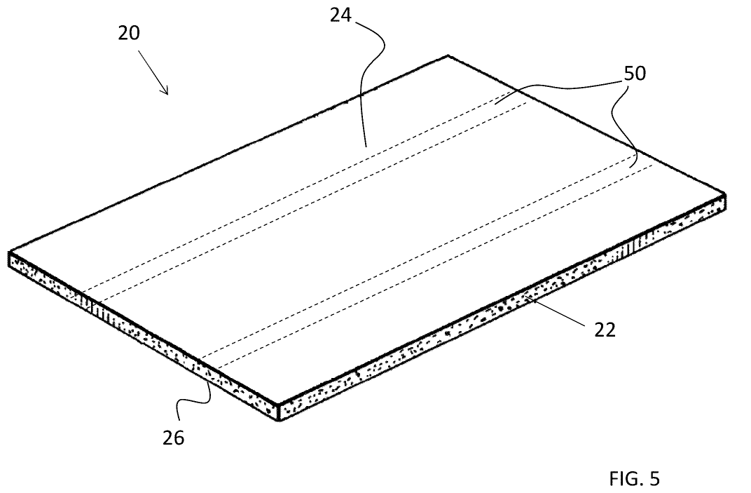

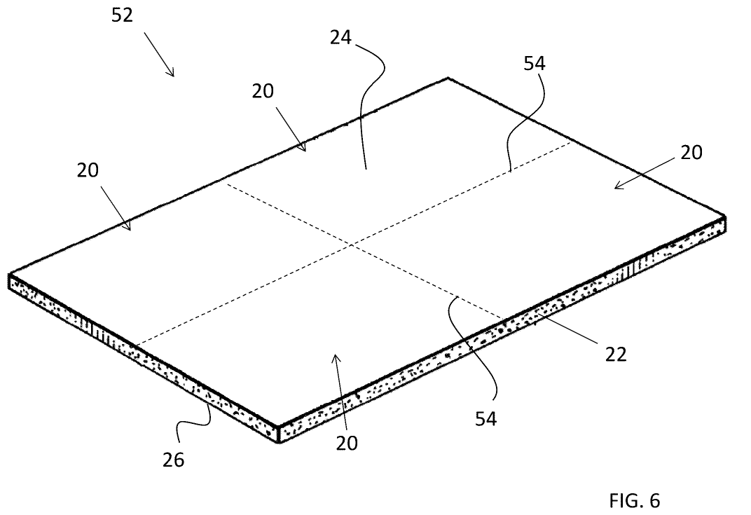

With reference now to FIG. 5, one or more regions of the core 22 of the cover board 20 is configured to receive fasteners when the cover board 20 is installed in an application. These regions are illustrated schematically at 50 by broken lines. In an embodiment, these regions 50 may be located at 16″ on center or 24″ on center. However, a region 50 for receiving a fastener located at any position about the core 22 is contemplated herein, such as along one or more edges of the core 22 for example. In addition, in the non-limiting embodiment illustrated in FIG. 6, multiple cover boards 20 may be integrally formed as a single sheet during a manufacturing process. The large sheet, illustrated at 52, is then cut along one or more edges 54 to form the plurality of similar or different cover boards 20.

To provide additional strength and rigidity to the core 22, the core 22 may be formed such that a concentration of material, such as recycled roof membrane material 30 for example, is greater within one or more desired areas of the core 22. In an embodiment, the areas of the core 22 having a greater concentration of recycled roof membrane material 30 include the one or more regions 50 of the core 22 of the cover board 20 configured to receive fasteners when the cover board 20 is installed in an application. Accordingly, the regions 50 of the core 22 may have a first concentration of recycled roof membrane material 30 and the remainder of the core 22 may have a second concentration of recycled roof membrane material 30, the concentration within the regions 50 being intentionally greater the concentration within the remainder of the core 22. In an embodiment, the concentration of recycled roof membrane material 30 within the regions 50 is between 10% and 50% greater than within the remainder of the core 22. By increasing the material within the regions 50, the regions 50 have increased fastener resistance.

Alternatively, or in addition, the areas including a greater concentration of recycled roof membrane material 30 may include the portions of the large cover board 52 generally adjacent to the cuts 54 formed therein. For example, the areas having an increased concentration of recycled roof membrane material 30 may extend one, two, or three or more inches in each direction from a cut line 54. Accordingly, a concentration of recycled roof membrane material 30 adjacent to the edges of the cut cover boards 20 may be greater than the concentration of recycled roof membrane material 30 within a central portion of the cut cover boards 20. In an embodiment, the concentration of recycled roof membrane material 30 adjacent the edges and/or cut lines 54 is between 10% and 50% greater than the concentration within a center of the cover board 20.

Because of the water-resistance of recycled roof membrane, a cover board 20 including recycled roof membrane material 30 as described herein is more durable than existing construction boards, such as plywood, oriented strand board (OSB), wafer board, and gypsum board which absorb water and support the growth of mold, mildew, and fungus. A cover board 20 including recycled roof membrane as described herein may be recyclable in perpetuity.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description but is only limited by the scope of the appended claims.

What is claimed is:

1. A cover board for use in a roofing system, comprising:
a core including material from at least one recycled roof membrane, the core having a first major surface and a second major surface; and
a facing layer adjacent to at least one of the first major surface and the second major surface.

2. The cover board of claim 1, wherein the material from the at least one recycled roof membrane includes a thermoplastic membrane.

3. The cover board of claim 2, wherein the material from the at least one recycled roof membrane includes a polyvinyl chloride (PVC).

4. The cover board of claim 2, wherein the material from the at least one recycled roof membrane includes a thermoplastic polyolefin (TPO).

5. The cover board of claim 2, wherein the material from the at least one recycled roof membrane includes a Ketone Ethylene Ester (KEE).

6. The cover board of claim 1, wherein the material from the at least one recycled roof membrane includes a thermoset membrane.

7. The cover board of claim 6, wherein the material from the at least one recycled roof membrane includes an ethylene propylene diene terpolymer (EPDM).

8. The cover board of claim 1, wherein the core further includes a compatible plastic material, the material from the at least one recycled roof membrane being encapsulated by the compatible plastic material.

9. The cover board of claim 8, wherein the compatible plastic material includes polyester.

10. The cover board of claim 8, wherein the compatible plastic material includes polyethylene.

11. The cover board of claim 8, wherein the compatible plastic material includes polyvinyl chloride.

12. The cover board of claim 1, wherein the core has at least one region and a concentration of the material from the at least one recycled roof membrane within the at least one region is greater than a concentration of the material from the at least one recycled roof membrane within a remainder of the core.

13. The cover board of claim 12, wherein the at least one region includes an area for receiving fasteners when the cover board is installed in the roofing system.

14. The cover board of claim 1, wherein the material from the at least one recycled roof membrane is strengthened by at least one additive.

15. The cover board of claim 14, wherein the at least one additive includes chopped organic fibers.

16. The cover board of claim 14, wherein the at least one additive includes chopped inorganic fibers.

17. The cover board of claim 1, wherein the facing layer includes a sheet of recycled roof membrane.

18. The cover board of claim 1, wherein the facing layer includes a construction paper.

19. The cover board of claim 1, wherein the cover board has a weight between 1 pound/square foot and 25 pounds/square foot.

20. The cover board of claim 1, wherein the core of the cover board is waterproof.
